(19) United States
(12) Patent Application Publication
(10) Pub. No.: US 2025/0319713 A1
(43) Pub. Date: Oct. 16, 2025

(54) RECORDING APPARATUS

(71) Applicant: CANON KABUSHIKI KAISHA, Tokyo (JP)

(72) Inventors: YOHEI KUSANO, Tokyo (JP); RYO KOBAYASHI, Kanagawa (JP); KOSUKE YASUDA, Kanagawa (JP)

(21) Appl. No.: 19/095,341

(22) Filed: Mar. 31, 2025

(30) Foreign Application Priority Data
Apr. 11, 2024 (JP) 2024-064010

(51) Int. Cl. B41J 29/393; B41J 15/04; B41J 29/13; B41J 29/377

(52) U.S. Cl. CPC B41J 29/393; B41J 15/048; B41J 29/13; B41J 29/377

(57) ABSTRACT

Provided is a recording apparatus, including: a first processing casing which includes a first conveying path and a first processing portion configured to perform processing on a recording medium conveyed by the first conveying path; a second processing casing which includes a second conveying path and a second processing portion configured to perform processing on a recording medium conveyed by the second conveying path; a first electric casing which includes a first electric portion to control the first processing portion; and a second electric casing which includes a second electric portion to control the second processing portion. The first electric casing is separably linked to the first processing casing in a width direction of the recording medium, and the second electric casing is separably linked to the second processing casing in the width direction independently from the first electric casing.

### BACKGROUND OF THE INVENTION

### Field of the Invention

The present invention relates to a recording apparatus.

### Description of the Related Art

In a recording apparatus that records images on a recording medium, a processing portion (such as a recording portion to record an image on the recording medium, and a fixing portion to fix the image to the recording medium) and an electric portion to control the processing portion, are disposed. It is preferable that the processing portion and the electric portion can be easily accessed for maintenance by an operator.

Japanese Patent Application Publication No. 2017-209894 discloses a recording apparatus, including: an apparatus main body in which a processing portion is disposed; and an electric casing in which an electric portion is disposed and which is rotatably supported by the apparatus main body. In the case of this configuration, the operator can open the electric casing from the apparatus main body, so that the processing portion is exposed to the outside, and can access the processing portion and the electric portion.

### SUMMARY OF THE INVENTION

In the case of the above mentioned configuration, however, a space to rotate the electric casing is required, which increases a potential ground contact area of the recording apparatus. Further, in the case of a recording apparatus in which a plurality of casings are disposed next to each other, the above mentioned configuration may not be used since the electric casing cannot be rotated.

With the foregoing in view, it is an object of the present invention to provide a recording apparatus which excels in operability to perform maintenance.

To achieve the above object, the recording apparatus of the present invention includes:
a first processing casing which includes a first conveying path configured to convey a recording medium in a conveying direction, and a first processing portion configured to perform processing on a recording medium conveyed by the first conveying path;
a second processing casing which includes a second conveying path configured to convey a recording medium in a conveying direction, and a second processing portion configured to perform processing on a recording medium conveyed by the second conveying path;
a first electric casing which includes a first electric portion to operate the first processing portion, and which is separably linked to the first processing casing in a width direction of the recording medium which intersects with the conveying direction; and
a second electric casing which includes a second electric portion to operate the second processing portion, and which is separably linked to the second processing casing in the width direction independently from the first electric casing.

According to the present invention, a recording apparatus that can improve efficiency of the maintenance operation for the electric portion and the functional portions of the apparatus main body, while suppressing an increase in the size of the apparatus and installation area, can be provided.

Further features of the present invention will become apparent from the following description of exemplary embodiments with reference to the attached drawings.

### BRIEF DESCRIPTION OF THE DRAWINGS

FIG. 1 is a schematic cross-sectional view depicting an internal configuration of a recording apparatus;

FIG. 2 is a perspective view of a casing of a sheet conveying portion of a recording portion;

FIG. 3 is a perspective view of a lifting mechanism of a recording head;

FIGS. 4A to 4C are general views of the recording apparatus;

FIGS. 5A to 5C are perspective views of casings of an electric casing portion;

FIGS. 6A and 6B are diagrams for describing shipment and transportation of the casing;

FIGS. 7A and 7B are diagrams for describing the air flow concept inside the casings according to Embodiment 1; and

FIGS. 8A and 8B are diagrams depicting the inside of the casings according to Embodiment 2.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

### Embodiment 1

### Recording Apparatus

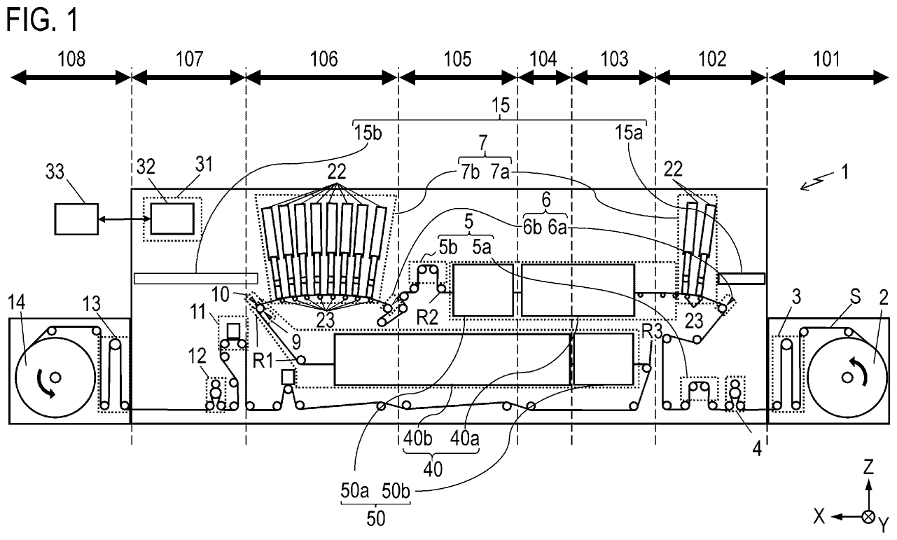

A recording apparatus 1 (printer) according to Embodiment 1 of the present invention will be described. FIG. 1 is a schematic cross-sectional view depicting an internal configuration of the recording apparatus 1. The recording apparatus 1 is a high-speed line printer that uses, as a recording medium, a continuous sheet (hereafter sheet S) of which end portion is rolled. In the following description, it is defined that the vertical direction in FIG. 1 is the vertical direction (perpendicular direction) of the recording apparatus 1, the left-right direction is the longitudinal direction of the recording apparatus 1, and the depth direction from the front side to the back side of the page is the width direction of the recording apparatus 1. The conveying direction of the sheet S in the recording apparatus 1 is the direction intersecting with the width direction (intersecting orthogonally in this example). The width direction of the sheet S, in a conveyed state, is approximately parallel with the width direction of the recording apparatus 1. In the drawings, the X direction is the longitudinal direction of the recording apparatus 1, the Y direction is the width direction thereof, and the Z direction is the vertical direction thereof. The X direction, the Y direction and the Z direction are orthogonal to each other.

As processing portions to perform predetermined processing on the sheet S, the recording apparatus 1 according to Embodiment 1 includes an unwinding roll portion 2, a first dancer portion 3, a first main conveying portion 4, a meandering correcting portion 5, a conveying detecting portion 6, and a recording portion 7. Further, as processing portions, the recording apparatus 1 includes a conveying tension detecting portion 9, a recording image position detecting portion 10, a scanner portion 11, a second main conveying portion 12, a second dancer portion 13, a winding roll portion 14, a maintenance portion 15, a drying portion 40, and a cooling portion 50. All of these processing units are disposed inside the recording apparatus 1. The continuous sheet S (recording medium) is conveyed along a sheet conveying path indicated by a solid line in FIG. 1, and is processed by each unit. Some of these units may be disposed in a plurality of locations in the recording apparatus 1. In the following description, a plurality of same units that are disposed are described individually with an attached subscript if necessary. Further, in the following description, the conveying direction of the sheet S of the recording apparatus 1 is the direction from the unwinding roll portion 2 to the winding roll portion 14, but the recording apparatus 1 may be configured such that the sheet S can be conveyed from the winding roll portion 14 to the unwinding roll portion 2.

The recording apparatus 1 includes a first recording step portion and a second recording step portion along a sheet conveying path (sheet S). The second recording step portion is located on the downstream side of the first recording step portion in the sheet S conveying direction of the sheet S. The first recording step portion includes a first recording portion 7a, a first drying portion 40a, and a first cooling portion 50a, and as the sheet S passes through each unit, the image is fixed and recorded on the sheet S. The second recording step portion includes a second recording portion 7b, a second drying portion 40b, and a second cooling portion 50b, and as the sheet S passes through each unit, the image is fixed and recorded on the sheet S, which passed through the first recording step. Thus in the recording apparatus 1, the sheet S passes through the first recording step portion and the second recording step portion, whereby images are recorded continuously on the sheet S. Further, the recording apparatus 1 can also optionally select the recording step portion according to the recording conditions. In this case, the image is recorded on the sheet S only in the selected recording step portion.

The unwinding roll portion 2 is a unit to hold and supply the continuous sheet which is wound in a roll. The unwinding roll portion 2 is configured to house an unwinding roll, and the sheet S is unwound and supplied. A number of rolls that can be housed is not limited to one, but may be two, three or more, and a sheet S may be optionally unwound and supplied.

The first dancer portion 3 is a unit (tension applying portion) which applies a predetermined tension to the sheet S between the unwinding roll portion 2 and the first main conveying portion 4. In the first dancer portion 3, tension is applied to the sheet S by tension applying means (not illustrated).

The first main conveying portion 4 is a unit (tension applying portion) which conveys the sheet S to each unit, which is disposed along the sheet conveying path (sheet S), and applies tension to the sheet S between the first main conveying portion 4 and the second main conveying portion 12. The first main conveying portion 4 includes rollers which are rotated by a motor (not illustrated), and convey the sheet S in a tensed state (convey the sheet S while applying tension).

The meandering correcting portion 5 is a unit to correct the meandering of the sheet S in the width direction when the sheet S is conveyed in a tensed state. The meandering correcting portion 5 includes a first meandering correcting portion 5a which is disposed on the upstream side of the first recording portion 7a on the sheet conveying path, and a second meandering correcting portion 5b which is disposed on the downstream side of the first cooling portion 50a, and on the upstream side of the second recording portion 7b. The first meandering correcting portion 5a and the second meandering correcting portion 5b include meandering correcting rollers and a meandering detecting sensor (not illustrated) to detect meandering of the sheet S respectively. By the meandering correcting rollers, inclination of the sheet S can be changed using the motor (not illustrated), and meandering of the sheet S is corrected based on the measurement by the meandering detecting sensor. The meandering correcting portion 5 improves the function of the meandering correction by winding the sheet S around the meandering correcting rollers.

The conveying detecting portion 6 is a unit to detect the conveying speed of the sheet S and a mark which is printed on the sheet S in advance, so as to control the image forming timing at the recording portion 7. The conveying detecting portion 6 includes: a first conveying detecting portion 6a, which is disposed on the downstream side of the first meandering correcting portion 5a and on the upstream side of the first recording portion 7a; and a second conveying detecting portion 6b, which is disposed on the downstream side of the second meandering correcting portion 5b and on the upstream side of the second recording portion 7b, on the sheet conveying path. The first conveying detecting portion 6a is used for controlling an image forming timing of the first recording portion 7a, and the second conveying detecting portion 6b is used for controlling an image forming timing of the second recording portion 7b.

The recording portion 7 is a sheet processing portion which applies liquid composition (ink) onto the conveyed sheet S using a recording head 22 from above, and forms an image thereon. The conveying path of the recording portion 7 is formed by guide rollers 23 disposed arc-shaped projecting upward, and a clearance with the recording head 22 can be maintained by a predetermined tension applied to the sheet S. In the recording portion 7, a plurality of recording heads 22 are disposed side by side along the sheet conveying path. The recording head 22 in Embodiment 1 is a line type recording head.

The recording portion 7 of the recording apparatus 1 includes the first recording portion 7a and the second recording portion 7b. The first recording portion 7a and the second recording portion 7b are disposed distant from each other, and the second recording portion 7b is disposed on the downstream side of the first recording portion 7a in the sheet conveying direction. The first recording portion 7a includes a total of 2 line type recording heads corresponding to white (W) ink and a reaction solution. The second recording portion 7b includes a total of 8 line type recording heads corresponding to 4 colors (black (Bk), yellow (Y), magenta (M) and cyan (C)), a reaction solution, and 3 special colors.

The reaction solution is a liquid containing components to increase the viscosity of the ink. An “increase in the viscosity of the ink” here means an increase in the viscosity of the ink caused by a chemical reaction or a physical adsorption generated when color material, resin or the like constituting the ink contact with the components to increase the viscosity of the ink. An increase in the viscosity of ink is not limited to a general increase in the viscosity of ink, but includes a case of a local increase in the viscosity of ink caused by partial aggregation of the components constituting ink (e.g. color material, resin). The components that increase the viscosity of ink are not especially limited, and may be metal ions or polymer flocculants. For the component to cause an increase in the viscosity of ink, a substance that aggregates the color material in ink by changing the pH of the ink can be used, and organic acid, for example, can be used.

If the reaction solution is applied to the sheet S in advance before applying ink, the ink which reaches the sheet S can be fixed onto the sheet S immediately. This can prevent bleeding caused by mixing ink of adjacent recording heads. The color types, the number of colors, and the number of recording heads 22 are not limited to those described above. For the inkjet type, a type using heating elements, a type using piezoelectric elements, a type using electrostatic elements, a type using MEMS elements, and the like, may be used. Ink is supplied from the ink tank (not illustrated) to each recording head 22 via an ink tube respectively.

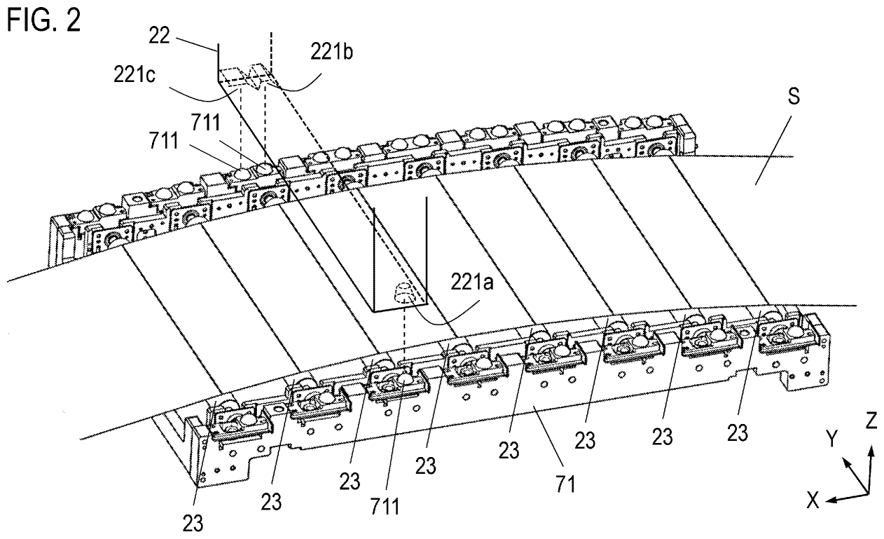

The recording portion 7 includes a conveying portion casing 71 in which a plurality of positioning members 711, to position the recording heads 22, are disposed. FIG. 2 is a perspective view depicting details of the conveying portion casing 71 of the recording portion 7. In each recording head 22, one positioning member 711 is disposed on one side, and two positioning members 711 are disposed on the other side of the sheet S in the width direction of the sheet S. Further, on each recording head 22, positioned portions 221a, 221b and 221c are disposed corresponding to the positioning members 711.

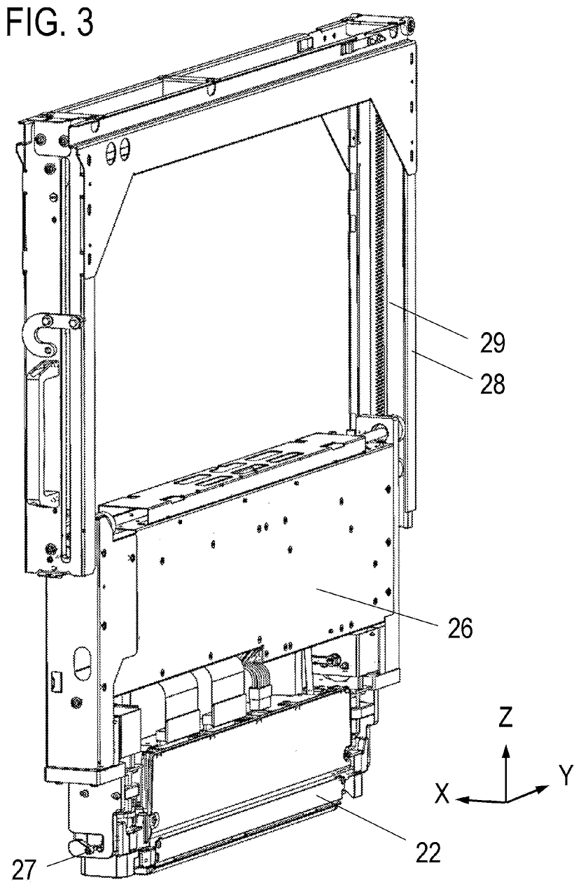

The recording head 22 is disposed to face the recording surface of the sheet S, and can approach or separate from the sheet S. FIG. 3 is a diagram depicting a lifting mechanism of the recording head 22. As illustrated in FIG. 3, the recording head 22 includes a recording head supporting shaft 27, and is supported by a recording head holding portion 26 which holds the recording head 22 and moves the recording head 22 up and down, so as to support the recording head supporting shaft 27 from the bottom. The recording head holding portion 26 moves up and down by the driving mechanism (not illustrated) included in the recording head holding portion 26, along a lifting rail 29 disposed inside a recording head lifting frame 28. In Embodiment 1, ink is applied onto the sheet S using the recording head 22, which is an inkjet head, but the method for the recording portion 7 to apply ink onto the sheet S is not limited to this. For example, the reaction solution may be applied to the sheet S not by the recording head 22 but by a roller, a die coating apparatus (die coater), a blade coating apparatus (blade coater) or the like.

The conveying tension detecting portion 9 is a unit to detect tension when the sheet S is conveyed with tension between the first main conveying portion 4 and the second main conveying portion 12. The recording image position detecting portion 10 detects deviation of the image, which was formed on the sheet S by the recording portion 7, during printing (recording operation), and corrects the printing. The conveying tension detecting portion 9 and the recording image position detecting portion 10 are disposed on the downstream side of the second recording portion 7b and on the upstream side of the second drying portion 40b in the conveying direction.

The drying portion 40 is a unit to decrease the liquid contained in the liquid composition, which was applied onto the sheet S by the recording portion 7, and to improve the fixing performance between the sheet S and the ink. The drying portion 40 of the recording apparatus 1 includes the first drying portion 40a and the second drying portion 40b. The first drying portion 40a is located on the sheet conveying path on the downstream side of the first recording portion 7a in the conveying direction. The second drying portion 40b is located on the sheet conveying path on the downstream side of the second recording portion 7b in the conveying direction.

The drying portion 40 blows air to the sheet S on which an image is recorded, so as to dry the applied ink. Inside the drying portion 40, air is blown at least from the ink applying surface side of the sheet S to the sheet S that is passing, so that the ink applied to the sheet S is dried. The drying method is not limited to the method of blowing air, and may be a method of emitting electromagnetic waves (e.g. ultraviolet rays, infrared rays) to the surface of the sheet S, or may be a conductive heat transfer method by contacting heating elements, or may be combination of these methods.

The cooling portion 50 is a unit to cool the sheet S, on which the ink was fixed by the drying portion 40, so as to solidify the softened ink, and to control the temperature change amount of the sheet S in the steps on the downstream side of the recording apparatus 1. The cooling portion 50 of the recording apparatus 1 includes the first cooling portion 50a and the second cooling portion 50b. The first cooling portion 50a is located on the sheet conveying path on the downstream side of the first drying portion 40a in the conveying direction. The second cooling portion 50b is located on the sheet conveying path on the downstream side of the second drying portion 40b in the conveying direction.

Inside the cooling portion 50, air, of which temperature is lower than the sheet S, is blown to the sheet S that is passing, at least from the ink applying surface side of the sheet S, so that the ink applying surface of the sheet S is cooled. The cooling method is not limited to the method of blowing air, and may be a conductive heat transfer method of contacting a heating radiation member, or may be a combination of these methods.

The scanner portion 11 is a unit to read a test image which was formed on the sheet S by the recording portion 7 before printing, and to detect deviation and density of the image and make corrections for an actual printing. The scanner portion 11 is located on the sheet conveying path on the downstream side of the second cooling portion 50b in the conveying direction.

The second main conveying portion 12 is a unit to convey the sheet S while applying tension to the sheet S along with the first main conveying portion 4, and adjust the tension of the sheet S (tension applying portion). The second main conveying portion 12 includes rollers which are rotated by the driving force of a motor (not illustrated), and controls the roller speed using a tension control portion (not illustrated) in accordance with the tension value detected by the conveying tension detecting portion 9.

As an additional configuration to adjust the tension of the sheet S, a configuration to adjust the tension of the sheet S using a clutch (not illustrated), which can control the torque in the driving-connected structure, may be added to the recording apparatus 1. In this case, for the tension control method, a torque control method which controls the torque value transferred from the clutch, and a speed control method which controls the roller speed of the second main conveying portion 12, can be used. It is preferable to configure that allows switching between these two types of tension control methods depending on the purpose, and also allows using both of these methods simultaneously.

The second dancer portion 13 is a unit to apply a predetermined sheet tension between the second main conveying portion 12 and the winding roll portion 14 (tension applying portion). The second dancer portion 13 applies the sheet tension using tension applying means (not illustrated).

The winding roll portion 14 is a unit to wind the recorded sheet S around a winding core. A number of rolls to be collected is not limited to one, but two or three or more winding cores may be disposed and the sheet S may be collected, optionally switching between the winding cores. Depending on the processing content after recording, continuous sheets may be cut using a cutter, then the cut sheets S may be loaded, instead of winding the sheet S around the winding core.

The control portion 31 is a unit to control each component of the recording apparatus in general. The control portion 31 includes a CPU, a recording device, controllers that include various control units, an external interface, and an operation portion 32 where the user inputs/outputs data. The operation of the recording apparatus 1 is controlled based on commands from the controller or host device 33 (e.g. host computer), which is connected to the controller via the external interface.

The maintenance portion 15 is a unit including a mechanism to recover the ejection performance of the recording head 22. The recovery mechanism of the recording head 22 may include, for example, a cup mechanism to protect the ink ejection surface of the recording head 22, a wiper mechanism to wipe the ink ejection surface, and a suction mechanism to suck the ink in the recording head 22 from the ink ejection surface using negative pressure. The maintenance portion 15 includes a driving mechanism and a rail (both not illustrated), so that reciprocal movement in the horizontal direction is possible along the rail. The maintenance portion 15 moves to a position directly under the recording head 22 in the case of performing maintenance of the recording head 22, and moves to a position retracted from the position directly under the recording head 22 when the maintenance operation is not performed. The maintenance portion 15 includes a first maintenance portion 15a which corresponds to the first recording portion 7a, and a second maintenance portion 15b which corresponds to the second recording portion 7b.

The conveying portion of the recording apparatus 1 includes a plurality of guide rollers, such as winding guide rollers R1, R2 and R3. The winding guide roller R1 is located on the downstream side of the second recording portion 7b in the conveying direction, and is a roller to wind the surface of the sheet S on the opposite side of the ink applying surface at a predetermine winding angle. In Embodiment 1, two winding guide rollers R1 are disposed on the sheet conveying path between the second recording portion 7b and the second drying portion 40b, and the sheet S is conveyed to return approximately in parallel. One of the winding guide rollers R1 is located approximately at the same height as the second recording portion 7b, and the other winding guide roller R1 is located approximately at the same height as the second drying portion 40b and below the second recording portion 7b.

The winding guide roller R2 is located on the sheet conveying path between the first cooling portion 50a and the second meandering correcting portion 5b, and is a roller to wind the surface of the sheet S on the opposite side of the ink applying surface at a predetermined winding angle. The winding guide roller R2 guides the sheet S, that passed the first cooling portion 50a, upward toward the second meandering correcting portion 5b.

The winding guide roller R3 is located on the sheet conveying path on the downstream side of the second cooling portion 50b in the conveying direction, and is a roller to wind the surface of the sheet S on the opposite side of the ink applying surface at a predetermined winding angle. The winding guide roller R3 guides the sheet S, that passed the second cooling portion 50b, downward.

### Casing of Recording Apparatus

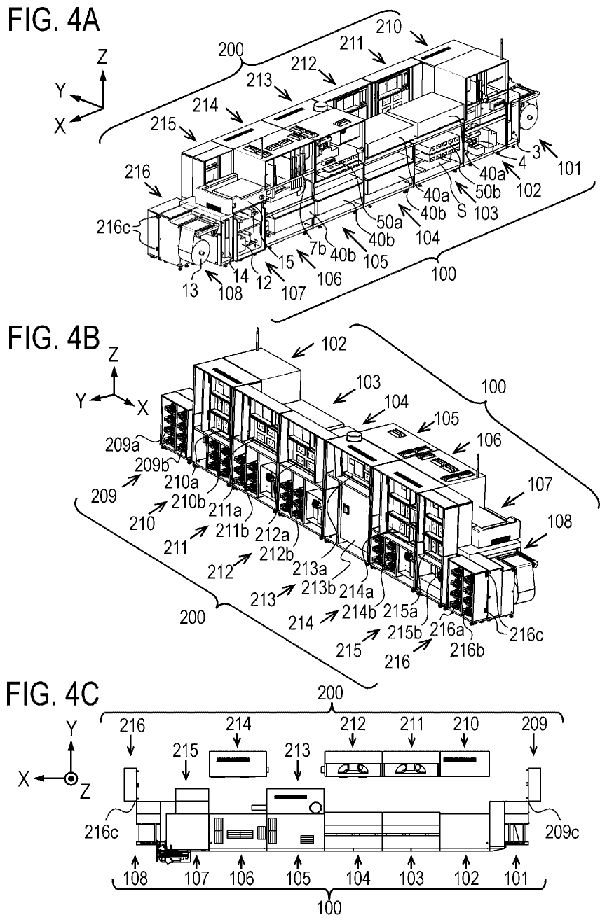

A casing constituting the recording apparatus 1 according to Embodiment 1 will be described next. The recording apparatus 1 includes a main body casing portion 100 configured by a plurality of casings, and an electric casing portion 200 configured by a plurality of casings. FIGS. 4A to 4C are general views of the recording apparatus 1. FIG. 4A is a perspective view of the recording apparatus 1 viewed from the side of the main body casing portion 100, where a part of the external cover is not illustrated. FIG. 4B is a perspective view of the recording apparatus 1 viewed from the side of the electric casing portion 200, where a part of the exterior cover is not illustrated. FIG. 4C is a plan view of the recording apparatus 1 viewed from the top face side (from above), where a part of the exterior cover is not illustrated. FIG. 4C indicates a state where a part of the casings of the electric casing portion 200 is separated from the main body casing portion 100 in the Y direction.

The main body casing portion 100 and the electric casing portion 200 are disposed next to each other in the Y direction (width direction). The main body casing portion 100 is constituted of eight casings, which are disposed side by side in the X direction (longitudinal direction). That is, the main body casing portion 100 is consisted of a first casing 101, a second casing 102, a third casing 103, a fourth casing 104, a fifth casing 105, a sixth casing 106, a seventh casing 107, and an eighth casing 108, which are disposed in this order side by side in the X direction. FIG. 1 indicates an approximate range where each casing, constituting the main body casing portion 100, is disposed. Each casing of the main body casing portion 100 is a conveying casing which includes a conveying path to convey the sheet S respectively, and is also a processing portion (processing unit) to process the sheet S that is conveyed via the conveying path respectively.

The electric casing portion 200 is constituted of eight casings which are disposed side by side in the X direction (longitudinal direction). That is, the electric casing portion 200 is constituted of a ninth casing 209, a tenth casing 210, an eleventh casing 211, a twelfth casing 212, a thirteenth casing 213, a fourteenth casing 214, a fifteenth casing 215, and a sixteenth casing 216, which are disposed in this order side by side in the X direction. Each casing of the electric casing portion 200 is an electric casing which includes an electric portion (electric unit) constituted of electric components to operate the processing portions of each casing of the main body casing portion 100 respectively.

The first casing 101 includes the unwinding roll portion 2 and the first dancer portion 3. The ninth casing 209 includes: a control substrate 209a to control operation, which functions as an electric portion to operate the unwinding roll portion 2 and the first dancer portion 3; and a power supply 209b, which functions as a driving source. The first casing 101 and the ninth casing 209 are disposed next to each other in the Y direction, and are linked to each other. The ninth casing 209 is linked to the first casing 101 so as to be rotatable around a hinge 209c. The ninth casing 209 may also be linked to the first casing 101 to be separable in the Y direction.

The second casing 102 includes the first main conveying portion 4, the first maintenance portion 15a and the first recording portion 7a. The tenth casing 210 includes: a control substrate 210a to control operation, which functions as an electric portion to operate the first main conveying portion 4, the first maintenance portion 15a and the first recording portion 7a; and a power supply 210b which functions as a driving source. The second casing 102 and the tenth casing 210 are disposed next to each other in the Y direction, and are linked to each other. As illustrated in FIG. 4C, the tenth casing 210 is separably linked to the second casing 102 in the Y direction, independently from the other casings of the electric casing portion 200.

The third casing 103 includes the first drying portion 40a and the second cooling portion 50b. The eleventh casing 211 includes: a control substrate 211a to control operation, which functions as an electric portion to operate the first drying portion 40a and the second cooling portion 50b; and a power supply 211b which functions as a driving source. The third casing 103 and the eleventh casing 211 are disposed next to each other in the Y direction, and are linked to each other. As illustrated in FIG. 4C, the eleventh casing 211 is separably linked to the third casing 103 in the Y direction, independently from the other casings of the electric casing portion 200.

The fourth casing 104 includes the first drying portion 40a and the second drying portion 40b. The twelfth casing 212 includes: a control substrate 212a to control operation, which functions as an electric portion to operate the first drying portion 40a and the second drying portion 40b; and a power supply 212b which functions as a driving source. The fourth casing 104 and the twelfth casing 212 are disposed next to each other in the Y direction, and are linked to each other. As illustrated in FIG. 4C, the twelfth casing 212 is separably linked to the fourth casing 104 in the Y direction, independently from the other casings of the electric casing portion 200.

The fifth casing 105 includes the second drying portion 40b and the first cooling portion 50a. The thirteenth casing 213 includes: a control substrate 213a to control operation, which functions as an electric portion to operate the second drying portion 40b and the first cooling portion 50a; and a power supply 213b which functions as a driving source. The fifth casing 105 and the thirteenth casing 213 are disposed next to each other in the Y direction, and are linked to each other. The thirteenth casing 213 is separably linked to the fifth casing 105 in the Y direction, independently from the other casings of the electric casing portion 200.

The sixth casing 106 includes the second drying portion 40b and the second recording portion 7b. The fourteenth casing 214 includes: a control substrate 214a to control operation, which functions as an electric portion to operate the second drying portion 40b and the second recording portion 7b; and a power supply 214b which functions as a driving source. The sixth casing 106 and the fourteenth casing 214 are disposed next to each other in the Y direction, and are linked to each other. As illustrated in FIG. 4C, the fourteenth casing 214 is separably linked to the sixth casing 106 in the Y direction, independently from the other casings of the electric casing portion 200.

The seventh casing 107 includes the scanner portion 11, the second main conveying portion 12 and the second maintenance portion 15b. The fifteenth casing 215 includes: a control substrate 215a to control operation, which functions as an electric portion to operate the scanner portion 11, the second main conveying portion 12 and the second maintenance portion 15b; and a power supply 215b which functions as a driving source. The seventh casing 107 and the fifteenth casing 215 are disposed next to each other in the Y direction, and are linked to each other. The fifteenth casing 215 is separably linked to the seventh casing 107 in the Y direction, independently from the other casings of the electric casing portion 200.

The eighth casing 108 includes the second dancer portion 13 and the winding roll portion 14. The sixteenth casing 216 includes: a control substrate 216a to control operation, which functions as an electric portion to operate the second dancer portion 13 and the winding roll portion 14; and a power supply 216b which functions as a driving source. The eighth casing 108 and the sixteenth casing 216 are disposed next to each other in the Y direction, and are linked to each other. The sixteenth casing 216 is linked to the eighth casing 108 so as to be rotatable around a hinge 216c. The sixteenth casing 216 may be linked to the eighth casing 108 separably in the Y direction.

To link the casings of the main body casing portion 100 and the casings of the electric casing portion 200, such connection means as screws, snap fits, cam-lock fasteners and connection pins may be used.

### Electric Casing Portion

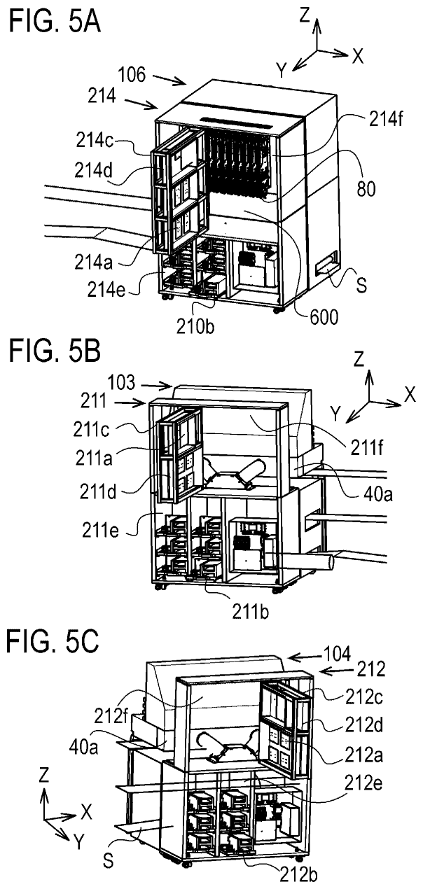

The casings (electric casings) constituting the electric casing portion 200 will be further described in detail. FIGS. 5A to 5C are diagrams for describing the casings constituting the electric casing portion 200. FIG. 5A is a perspective view of the fourteenth casing 214, where a part of the exterior cover is not illustrated. FIG. 5B is a perspective view of the eleventh casing 211, where a part of the exterior cover is not illustrated. FIG. 5C is a perspective view of the twelfth casing 212, where a part of the exterior cover is not illustrated.

### Fourteenth Casing 214

As illustrated in FIG. 5A, a door 214c, which is a member that can be opened or closed, is disposed in the upper portion of the fourteenth casing 214. In the door 214c, a plurality of substrate housing portions 214d are disposed, each of which houses the control substrate 214a of the second drying portion 40b and the second recording portion 7b. When the fourteenth casing 214 is viewed in the Y direction, the door 214c occupies approximately the upper half of the fourteenth casing 214.

At an end portion of the fourteenth casing 214 on the side of the sixth casing 106 (opposite side of the side where the door 214c is disposed), an opening 214f, which communicates the inside and the outside of the fourteenth casing 214, is formed. In the view in the Y direction, the substrate housing portion 214d in the door 214c, the opening 214f, and an ink circulating unit 80, are disposed at overlapping positions. Therefore by opening the door 214c, the operator can retract the substrate housing portion 214d from the front areas of the opening 214f and the ink circulating unit 80, and can access the ink circulating unit 80 through the opening 214f. In other words, the operator can perform maintenance of the ink circulating unit 80 merely by opening the door 214c, without removing parts or moving the casing. In the case where the sixth casing 106 and the fourteenth casing 214 are linked, the ink circulating unit 80 may be disposed extending over the sixth casing 106 to the fourteenth casing 214 via the opening 214f.

In the lower portion of the fourteenth casing 214, a plurality of power supply housing portions 214e are disposed, each of which houses the power supply 214b to operate the second drying portion 40b and the second recording portion 7b. When the fourteenth casing 214 is viewed in the Y direction, the plurality of power supply housing portions 214e occupy approximately the lower half of the fourteenth casing 214, and are located below the door 214c. The power supply 214b is supported by the fourteenth casing 214 so as to be drawable in the Y direction.

In Embodiment 1, one control substrate 214a is housed in each substrate housing portion 214d, and the weight of one substrate housing portion 214d, in which the control substrate 214a is disposed, is about 3 kg. The weight of one power supply 214b disposed in the power supply housing portion 214e is about 5 kg. In the fourteenth casing 214, six substrate housing portions 214d are disposed and six power supplies 214b are disposed. This means that the total weight of the substrate housing portions 214d located in the upper portion of the fourteenth casing 214 is about 18 kg, and the total weight of the power supplies 214b, disposed in the power supply housing portions 214e located in the lower portion of the fourteenth casing 214, is about 30 kg. In other words, the total weight of the plurality of substrate housing portions 214d, in which the control substrates 214a are disposed, is lighter than the total weight of the plurality of power supplies 214b. Because of this configuration, the center of gravity of the fourteenth casing 214 is located in the lower portion of the fourteenth casing 214, hence the attitude of the fourteenth casing 214 becomes stable during transportation and maintenance of the fourteenth casing 214.

### Eleventh Casing 211

As illustrated in FIG. 5B, a door 211c, which is a member that can be opened or closed, is disposed in the upper portion of the eleventh casing 211. In the door 211c, a substrate housing portion 211d, which houses the control substrate 211a of the first drying portion 40a and the second drying portion 40b, is disposed. When the eleventh casing 211 is viewed in the Y direction, the door 211c occupies approximately the upper half of the eleventh casing 211.

At an end portion of the eleventh casing 211 on the side of the third casing 103 (opposite side of the side where the door 203c is disposed), an opening 211f, which communicates the inside and the outside of the eleventh casing 211, is formed. In the view in the Y direction, the substrate housing portion 211d in the door 211c, the opening 211f and the first drying portion 40a are disposed at overlapping positions. Therefore by opening the door 211c, the operator can retract the substrate housing portion 211d from the front areas of the opening 211f and the first drying portion 40a, and can access the first drying portion 40a through the opening 211f. In other words, the operator can perform maintenance of the first drying portion 40a merely by opening the door 211c, without removing parts or moving the casing. In the case where the third casing 103 and the eleventh casing 211 are linked, the first drying portion 40a may be disposed extending over the third casing 103 to the eleventh casing 211 via the opening 211f.

In the lower portion of the eleventh casing 211, a plurality of power supply housing portions 211e are disposed, each of which houses the power supply 211b to operate the first drying portion 40a and the second cooling portion 50b. When the eleventh casing 211 is viewed in the Y direction, the plurality of power supply housing portions 21 le occupy approximately the lower half of the eleventh casing 211, and are located below the door 211c. The power supply 211b is supported by the eleventh casing 211 so as to be drawable in the Y direction.

In Embodiment 1, one control substrate 211a is housed in each substrate housing portion 211d, and the weight of one substrate housing portion 211d, in which the control substrate 211a is disposed, is about 3 kg. The weight of one power supply 211b, disposed in the power supply housing portion 211e, is about 5 kg. In the eleventh casing 211, four substrate housing portions 211d are disposed, and six power supplies 211b are disposed. This means that the total weight of the substrate housing portions 211d, located in the upper portion of the eleventh casing 211, is about 12 kg, and the total weight of the power supplies 211b, disposed in the power supply housing portions 211e located in the lower portion of the eleventh casing 211, is about 30 kg. In other words, the total weight of the plurality of substrate housing portions 211d, in which the control substrates 211a are disposed, is lighter than the total weight of the plurality of power supplies 211b. Because of this configuration, the center of gravity of the eleventh casing 211 is located in the lower portion of the eleventh casing 211, hence the attitude of the eleventh casing 211 becomes stable during transportation and maintenance of the eleventh casing 211.

### Twelfth Casing 212

As illustrated in FIG. 5C, a door 212c, which is a member that can be opened or closed, is disposed in the upper portion of the twelfth casing 212. In the door 212c, a plurality of substrate housing portions 212d are disposed, each of which houses the control substrate 212a of the second drying portion 40b and the second recording portion 7b. When the twelfth casing 212 is viewed in the Y direction, the door 212c occupies approximately the upper half of the twelfth casing 212.

At an end portion of the twelfth casing 212 on the side of the fourth casing 104 (opposite side of the side where the door 203c is disposed), an opening 212f, which communicates the inside and the outside of the twelfth casing 212, is formed. In the view in the Y direction, the substrate housing portion 212d in the door 212c, the opening 212f and the first drying portion 40a are disposed at overlapping positions. Therefore by opening the door 212c, the operator can retract the substrate housing portion 212d from the front areas of the opening 212f and the first drying portion 40a, and can access the first drying portion 40a through the opening 212f. In other words, the operator can perform maintenance of the first drying portion 40a merely by opening the door 212c, without removing parts or moving the casing. In the case where the fourth casing 104 and the twelfth casing 212 are linked, the first drying portion 40a may be disposed extending over the fourth casing 104 to the twelfth casing 212 via the opening 212f.

In the lower portion of the twelfth casing 212, a plurality of power supply housing portions 212e are disposed, each of which houses the power supply 212b to operate the first drying portion 40a and the second drying portion 40b. When the twelfth casing 212 is viewed in the Y direction, the plurality of power supply housing portions 212e occupy approximately the lower half of the twelfth casing 212, and are located below the door 212c. The power supply 212b is supported by the twelfth casing 212 so as to be drawable in the Y direction.

In Embodiment 1, one control substrate 212a is housed in each substrate housing portion 212d, and the weight of one substrate housing portion 212d, in which the control substrate 212a is disposed, is about 3 kg. The weight of one power supply 212b, disposed in the power supply housing portion 212e, is about 5 kg. In the twelfth casing 212, four substrate housing portions 212dare disposed, and six power supplies 212b are disposed. This means that the total weight of the substrate housing portions 212d, located in the upper portion of the twelfth casing 212, is about 12 kg, and the total weight of the power supplies 212b, disposed in the power supply housing portion 212e located in the lower portion of the twelfth casing 212, is about 30 kg. In other words, the total weight of the plurality of substrate housing portions 212d, in which the control substrates 212a are disposed, is lighter than the total weight of the plurality of power supplies 212b. Because of this configuration, the center of gravity of the twelfth casing 212 is located in the lower portion of the twelfth casing 212, hence the attitude of the twelfth casing 212 becomes stable during transportation and maintenance of the twelfth casing 212.

### Other Electric Casings

In Embodiment 1, the tenth casing 210 and the thirteenth casing 213 are configured in the same way mentioned above as the casings of the electric casing portion 200. In other words, the operator can open the door of the tenth casing 210 and access the processing portions and the like of the second casing 102 through the opening formed in the tenth casing 210. In the tenth casing 210, the total weight of the plurality of control substrates 210a and the plurality of substrate housing portions disposed in the upper portion is lighter than the total weight of the plurality of power supplies 210b disposed in the lower portion. Further, the operator can open the door of the thirteenth casing 213 and access the processing portions and the like of the fifth casing 105 through the opening formed in the thirteenth casing 213. In the thirteenth casing 213, the total weight of the plurality of control substrates 213a and the plurality of substrate housing portions disposed in the upper portion is lighter than the total weight of the plurality of power supplies 213b disposed in the lower portion. The ninth casing 209 and the sixteenth casing 216 may also be configured in the same way.

As mentioned above, in the case of maintenance of the processing portion and the like, the linkage of the casing (electric casing) of the electric casing portion 200 and the casing (processing casing) of the main body casing portion 100 is cleared, and the electric casing is moved from the processing casing, whereby the operator can access the processing portion and the electric portion. The operator can also access the processing portion and the electric portion by opening the door of the electric casing, and exposing the processing portion and the electric portion. By this configuration, the processing portion can be disposed at the center of the recording apparatus in the Y direction, and the operator can easily access the processing portion. This can prevent the center of the recording apparatus in the Y direction from becoming hollow due to disposing of the process portion at the end of the recording apparatus in the Y direction, hence the internal space of the casing can be effectively used, and the size of the apparatus can be kept small. Particularly in the case of a large printing apparatus, such as an industrial printer, the distance from the exterior door of the casing to the processing portion becomes long if the processing portion is located at the center, hence it is preferable to apply this configuration to the recording apparatus.

Further, in the tenth casing 210, the eleventh casing 211, the twelfth casing 212, the thirteenth casing 213, the fourteenth casing 214 and the fifteenth casing 215, the substrate housing portions and the power supply housing portions are configured such that the respective center of gravities are on the lower side. By this configuration, the attitude of the casings becomes stable during transportation and maintenance of the casings, and the risk of tilting and falling is reduced.

### Shipment and Transportation of Casings

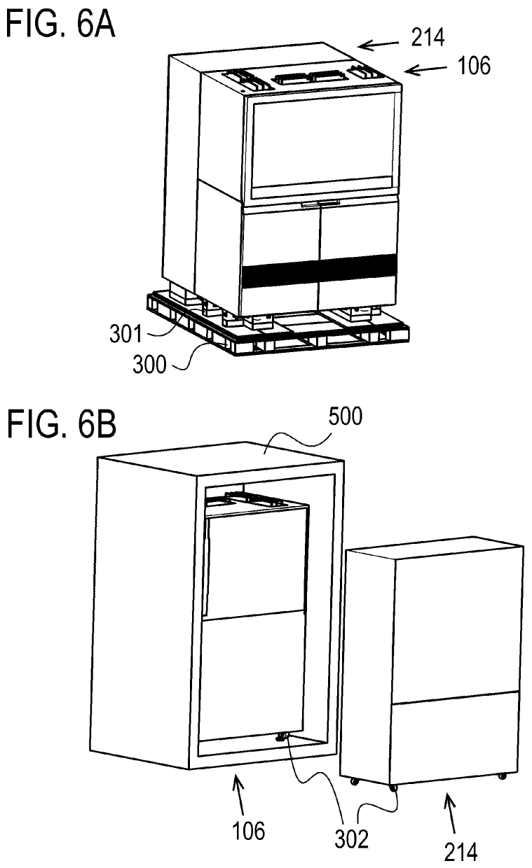

Shipment and transportation of the casings constituting the recording apparatus 1 will be described next, using the sixth casing 106 and the fourteenth casing 214 as an example. FIGS. 6A and 6B are diagrams for describing the shipment and transportation of the casings. FIG. 6A is a diagram depicting a state where the sixth casing 106 and the fourteenth casing 214 are shipped. FIG. 6B is a diagram for describing the loading of the sixth casing 106 and the fourteenth casing 214 on an elevator 500.

As illustrated in FIG. 6A, the sixth casing 106 and the fourteenth casing 214 are linked to each other, and are loaded on a receiving member 301 on a palette 300 in this state, and packaged together. The general dimensions of the sixth casing 106 are a 1400 mm width, a 900 mm depth, and a 1910 mm height. The general dimensions of the fourteenth casing 214 are a 1400 mm width, a 600 mm depth, and a 1910 mm height. Therefore the general dimensions of the sixth casing 106 and the fourteenth casing 214 that are linked together are a 1400 mm width, a 1500 mm depth, and a 1910 mm height.

The casings are transported to the destination where the recording apparatus 1 is installed, in a state illustrated in FIG. 6A, and are unpacked at the destination. Both the sixth casing 106 and the fourteenth casing 214 have casters 302, and can be transported to the installation location together after unpacking. If the passageways are narrow, the sixth casing 106 and the fourteenth casing 214 may be separated and transported independently.

The casings may be transported using an elevator. Therefore it is preferable that the casings are configured to have a size that makes loading on an elevator possible. Various dimensions of elevators are specified in JISA 4301-1983.

The dimensions of an elevator car specified in the JIS standard will be described. Table 1 indicates the internal dimensions of elevator car that conform to JISA 4301-1983.

TABLE 1

| | | | Maximum | | | |
|---|---|---|---|---|---|---|
| | | Load | capacity | Internal dimensions | | |
| Intended | | weight | (number of | of car (mm) | | |
| use | Symbol | (kg) | people) | Frontage | Depth | Height |
| General | P-6-CO | 450 | 6 | 1400 | 850 | 2300 |
| usage | P-9-CO | 600 | 9 | | 1100 | |
| | P-11-CO | 750 | 11 | | 1350 | |
| | P-13-CO | 900 | 13 | 1600 | | |
| | P-15-CO | 1000 | 15 | 1600 | 1500 | |
| | | | | 1800 | 1300 | |
| | P-17-CO | 1150 | 17 | 1800 | 1500 | |
| | | | | 2000 | 1350 | |
| | P-20-CO | 1350 | 20 | 1800 | 1700 | |
| | | | | 2000 | 1500 | |
| | P-24-CO | 1600 | 24 | 2000 | 1750 | |
| | | | | 2150 | 1600 | |

An elevator symbol is expressed by: a “symbol to indicate type/intended use”, a “number to indicate capacity or load weight (kg)”, and a “symbol to indicate door type”.

“Symbol to indicate type/intended use” is as follows:
P: rope type/general usage
R: rope type/home use
RT: rope type/home use with trunk
B: rope type/bed use
E: rope type/emergency use
HP: hydraulic type/general usage
HR: hydraulic type/home use

“Symbol to indicate door type” is as follows:
CO: double sliding doors
2S: two single sliding doors

As mentioned above, the dimensions of the sixth casing 106 and the fourteenth casing 214 in the linked state are: a 1400 mm width and a 1500 mm depth. Therefore in the linked sate, the sixth casing 106 and the fourteenth casing 214 cannot be loaded on the elevator 500 (1400 mm frontage, 1100 mm depth) of P-9-CO (rope type-general usage—for 9 people—double sliding doors) indicated in Table 1, for example. However in Embodiment 1, the sixth casing 106 and the fourteenth casing 214 can be separated from each other, and can be loaded on the elevator 500 individually in a separated state.

The above mentioned dimensional relationship of the sixth casing 106 and the fourteenth casing 214 is the same for the other processing casings of the main body casing portion 100 and electric casings of the electric casing portion 200. In other words, in Embodiment 1, the width in the Y direction of the processing casing and the width in the Y direction of the electric casing are less than 1.1 m respectively, and the total of the width in the Y direction of the processing casing and the width in the Y direction of the electric casing is 1.1 m or more. Because of this configuration, the casings constituting the recording apparatus 1 can be loaded on the elevator 500 and can be transported. The dimensions of the casings in Embodiment 1 are examples, and can be changed as required, but it is preferable that the widths in the Y direction of the processing casing and the electric casing are less than 1.1 m, considering the standard dimensions of elevators.

### Air Flow Concept of Casings

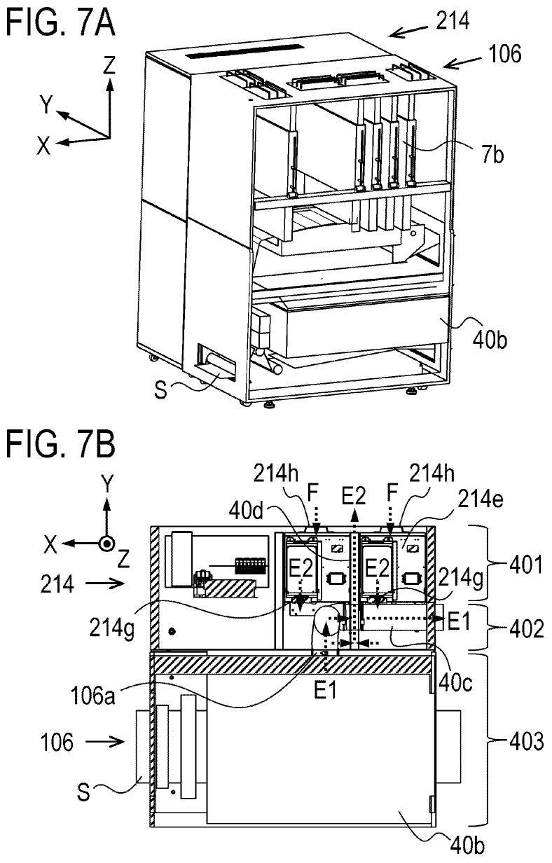

The air flow concept of the casings constituting the recording apparatus 1 will be described next using the sixth casing 106 and the fourteenth casing 214 as an example. FIGS. 7A and 7B are diagrams for describing the air flow concept of the casings. FIG. 7A is a perspective view of the sixth casing 106 and the fourteenth casing 214. FIG. 7B is a cross-sectional view of the sixth casing 106 and the fourteenth casing 214 viewed from the top face side, and is a cross-sectional view indicating the second drying portion 40b and the power supply housing portion 214e. In FIG. 7B, the general direction of the air flow inside the fourteenth casing 214 is indicated by a dotted line with an arrow.

Inside the fourteenth casing 214, a first space 401 where the substrate housing portion 214d and the power supply housing portion 214e are disposed, and a second space 402 which is partitioned from the first space 401, are formed. The first space 401 is located on the side distant from the sixth casing 106 in the Y direction, and the second space 402 is located on the side close to the sixth casing 106 in the Y direction. The first space 401 and the second space 402 communicate via a communication hole 214g so that air flows between the first space 401 and the second space 402. In the sixth casing 106, a third space 403, which the second drying portion 40b and the second recording portion 7b are disposed, is formed. In other words, the first space 401, the second space 402 and the third space 403 are disposed side by side in the Y direction in this order.

In the sixth casing 106, a discharge port 106a is disposed to discharge the exhaust air E1 from the second drying portion 40b and the second recording portion 7b toward the fourteenth casing 214 via the third space 403. The fourteenth casing 214 includes an exhaust duct 40c, which is a hose connected to the discharge port 106a. The exhaust duct 40c constitutes a first exhaust path to discharge the exhaust air E1 to the outside, which is discharged from the discharge port 106a. The exhaust duct 40c is disposed in the second space 402, collects the exhaust air of the processing portion (second drying portion 40b and the second recording portion 7b) of the sixth casing 106 from the third space 403, and discharge this exhaust air to the outside.

In the fourteenth casing 214, an intake port 214h, to draw in the outside air F (fresh air from the outside) into the first space 401 is disposed. The fourteenth casing 214 includes a column-shaped duct 40d connected to the communication hole 214g. The column-shaped duct 40d constitutes a second exhaust path to discharge exhaust air E2 to the outside, which is discharged from the communication hole 214g. The column-shaped duct 40d is a part of a structure and is hollow inside. The column-shaped duct 40d is disposed extending over the first space 401 to the second space 402, collects the exhaust air of the power supply 214b of the fourteenth casing 214 and the like from the first space 401, and discharge this exhaust air to the outside. In other words, in the fourteenth casing 214, the outside air F, drawn in through the intake port 214h, is used in the first space 401 for cooling the substrate housing portion 214d and the power supply housing portion 214e, and is then discharged as the exhaust air E2 to the outside, through the communication hole 214g and the column-shaped duct 40d.

In Embodiment 1, because of the above mentioned configuration, the exhaust air of the first space 401 and the exhaust air of the third space 403 are discharged to the outside through the second space 402 via mutually different routes. In other words, in the fourteenth casing 214, the intake air drawn in to the first space 401 through the intake port 214h is not interrupted by the exhaust air from the third space 403, and the flow of the intake air and the flow of the exhaust air are separated, hence the first space 401 of the fourteenth casing 214 can be efficiently cooled.

The exhaust duct 40c of the second drying portion 40b exhausts air through the hose in this example, but the present invention is not limited to this. For example, the air may be exhausted through a filter. Further, the air is exhausted through the column-shaped duct 40d in this example, but the present invention is not limited to this. For example, the air may be exhausted using a piping duct, a hose, or the like. A fan to specify the air blowing direction may be disposed in the exhaust duct 40c or in the column-shaped duct 40d, to prevent a back flow of the air.

This air flow concept of the sixth casing 106 and the fourteenth casing 214 is the same for the other processing casings of the main body casing portion 100 and electric casings of the electric casing portion 200. In other words, in Embodiment 1, the air in the processing portions of the processing casing is exhausted to the outside through the first exhaust path formed in the second space inside the electric casing. The air, which the electric took from the outside to the first space where the electric portions are disposed, is exhausted through a second exhaust path, which is different from the first exhaust path, and is formed extending over the first space to the second space.

### Embodiment 2

Embodiment 2 of the present invention will be described next. In Embodiment 2, some electric casings constituting the electric casing portion 200 are different from Embodiment 1. In the following, in the configuration of Embodiment 2, only the electric casings of which configuration is different from Embodiment 1 will be described. A composing element of Embodiment 2 the same as Embodiment 1 will be denoted with a same reference sign, and description thereof will be omitted.

In Embodiment 1, the power supply housing portion 214e and the exhaust duct 40c are disposed in the same casing (fourteenth casing 214). In Embodiment 2, on the other hand, the recording apparatus 1 includes two fourteenth casings 214A and 214B, and the power supply housing portion 214e and the exhaust duct 40c are disposed in different casings respectively.

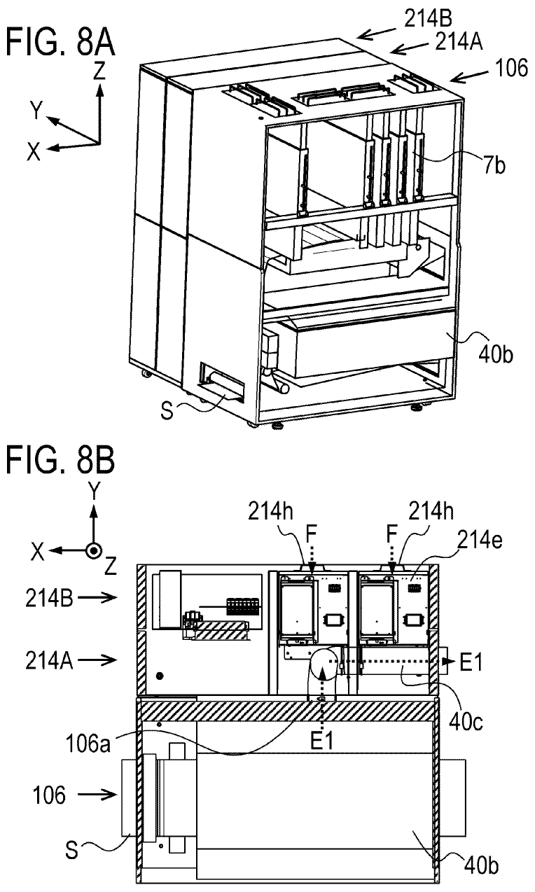

FIGS. 8A and 8B are diagrams for describing the electric casings of Embodiment 2. FIG. 8A is a perspective view of the sixth casing 106, the fourteenth casing 214 and the third casing 203B. FIG. 8B is a cross-sectional view of the sixth casing 106, the fourteenth casing 214 and the third casing 203B viewed from the top face side, and is a cross-sectional view indicating the second drying portion 40b and the power supply housing portion 214e. In FIG. 8B, a general direction of the air flow inside the fourteenth casing 214 is indicated by a dotted line with an arrow.

The fourteenth casing 214A is disposed next to the sixth casing 106 in the Y direction, and is separately linked to the sixth casing 106 in the Y direction. In the fourteenth casing 214A, the exhaust duct 40c, which is connected to the discharge port 106a of the sixth casing 106, is disposed. The exhaust air E1 of the sixth casing 106 is collected to the exhaust duct 40c through the discharge port 106a, passes through the inside of the fourteenth casing 214A, and is then discharged to the outside.

The fourteenth casing 214B is disposed next to the fourteenth casing 214A in the Y direction on the opposite side of the sixth casing 106, and is separately linked to the fourteenth casing 214B in the Y direction. In the fourteenth casing 214B the substrate housing portion 214d (not illustrated) and the power supply housing portion 214e are disposed. To link the fourteenth casing 214A and the fourteenth casing 214B, such connection means as screws, snap fits, cam-lock fasteners and connection pins may be used.

In the fourteenth casing 214B the intake port 214h, to draw in the outside air F (fresh air from the outside), is disposed. To discharge the outside air F, an exhaust path extending over the fourteenth casing 214A to the fourteenth casing 214B may be disposed, just like Embodiment 1, or a discharge port may be formed on the top face side, and an exhaust path, to guide the air to the discharge port, may be disposed.

Thus in Embodiment 2, the fourteenth casing 214B having the exhaust path is disposed between: the fourteenth casing 214A where the electric portions, such as the control substrate 214a and the power supply 214b, are disposed; and the sixth casing 106 where the processing portions, such as the second drying portion 40b and the second recording portion 7b, are disposed. In other words, the fourteenth casing 214A is connected to the sixth casing 106 separately in the Y direction via the fourteenth casing 214B.

As described above, in Embodiment 2, the casing to collect the exhaust air of the casings of the main body casing portion 100 and discharge the air to the outside, and the casing in which the electric portions to control the processing portions of the casings of the main body casing portion 100 are separately formed. Because of this configuration, the flow of the intake air and the flow of the exhaust air are separated, whereby the electric casings can be efficiently cooled.

The other casings may be configured in the same way as the sixth casing 106, the fourteenth casing 214A and the fourteenth casing 214B described above. In other words, an exhaust casing (e.g. fourteenth casing 214A), in which an exhaust path is formed, may be disposed between: an electric casing (e.g. fourteenth casing 214B) where the electric portion is disposed; and a processing casing (e.g. sixth casing 106) where the processing portion is controlled by this electric portion. The electric casing may be linked to the processing casing separately in the Y direction via the exhaust casing.

As described above, even in the case of disposing the substrate housing portion and the power supply housing portion in different casings from the casing of the exhaust duct, and configuring the electric casing portion 200 by a plurality of casings, the electric casings can be efficiently cooled by separating the flow of the intake air and the flow of the exhaust air. In the case where the electric casing portion 200 is constituted of a plurality of casings, the substrate housing portion and the power supply housing portion may be formed extending over the plurality of casings. Out of the plurality of electric casings constituting the recording apparatus 1, a part of the electric casings may be constituted of one casing, as in the case of Embodiment 1, and the rest of the electric casings may be constituted of a plurality of casings, as in the case of Embodiment 2.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-064010, filed on Apr. 11, 2024, which is hereby incorporated by reference herein in its entirety.

What is claimed is:

1. A recording apparatus, comprising:
a first processing casing which includes a first conveying path configured to convey a recording medium in a conveying direction, and a first processing portion configured to perform processing on a recording medium conveyed by the first conveying path;
a second processing casing which includes a second conveying path configured to convey a recording medium in a conveying direction, and a second processing portion configured to perform processing on a recording medium conveyed by the second conveying path;
a first electric casing which includes a first electric portion to operate the first processing portion, and which is separably linked to the first processing casing in a width direction of the recording medium which intersects with the conveying direction; and
a second electric casing which includes a second electric portion to operate the second processing portion, and which is separably linked to the second processing casing in the width direction independently from the first electric casing.

2. The recording apparatus according to claim 1, wherein
the first electric portion includes a control substrate configured to control operation of the first processing portion, and a power supply which is a driving source of the first processing portion.

3. The recording apparatus according to claim 2, wherein
the first electric casing includes a plurality of substrate housing portions which house the control substrate, and a plurality of power supply housing portions which are located below the substrate housing portions and which house the power supply, and wherein
a total weight of the plurality of control substrates and the plurality of substrate housing portions disposed inside the first electric casing is lighter than the total weight of the plurality of power supplies disposed inside the first electric casing.

4. The recording apparatus according to claim 3, wherein
the first electric casing includes an open/close member that is openable/closable, and the substrate housing portion is disposed in the open/close member, wherein
an opening to communicate the inside and the outside of the first electric casing is formed at an end portion of the first electric casing on the first processing casing side in the width direction, and wherein
the substrate housing portion, the opening, and the first processing portion are at overlapping positions when viewed in the width direction in a state where the open/close member is closed.

5. The recording apparatus according to claim 3, wherein
the power supply is housed in the power supply housing portion so as to be drawable from the power supply housing portion in the width direction.

6. The recording apparatus according to claim 1, wherein
the first processing casing includes a discharge port to discharge exhaust air of the first processing portion, and wherein
the first electric casing includes an exhaust path to collect exhaust air of the first processing portion through the discharge port and discharge the exhaust air to the outside of the first electric casing.

7. The recording apparatus according to claim 6, wherein
the first electric casing includes an intake port to draw in air from the outside of the first electric casing, and wherein
inside the first electric casing, the first electric portion is disposed, and a first space, to which air is drawn in through the intake port, and a second space, which is partitioned from the first space and in which the exhaust path is disposed, are formed.

8. The recording apparatus according to claim 7, wherein
in a case where the exhaust path is a first exhaust path, the first electric casing includes a second exhaust path to collect exhaust air from the first electric portion and discharge the exhaust air to the outside, and the second exhaust path is formed extending over the first space and the second space.

9. The recording apparatus according to claim 1, wherein
the first processing casing includes a discharge port to discharge exhaust air of the first processing portion, and wherein
the recording apparatus further comprises an exhaust casing including an exhaust path to collect exhaust air of the first processing portion through the discharge port and discharge the exhaust air to the outside, wherein
the exhaust casing is disposed between the first processing casing and the first electric casing in the width direction, is separably linked to the first processing casing in the width direction, and is separably linked to the first electric casing in the width direction.

10. The recording apparatus according to claim 1, wherein
a width of the first processing casing in the width direction and a width of the first electric casing in the width direction are less than 1.1 m respectively, and a total of the width of the first processing casing in the width direction and the width of the first electric casing in the width direction is 1.1 m or more, and wherein
a width of the second processing casing in the width direction and a width of the second electric casing in the width direction are less than 1.1 m respectively, and a total of the width of the second processing casing in the width direction and the width of the second electric casing in the width direction is 1.1 m or more.

11. The recording apparatus according to claim 1, wherein
the first processing portion and the second processing portion include at least one of: a tension applying portion configured to apply tension to the recording medium; a recording portion configured to record an image on the recording medium which is conveyed while receiving tension applied by the tension applying portion; a fixing portion configured to fix the image recorded by the recording portion onto the recording medium; and a cooling portion configured to cool the recording medium on which the image is fixed.

12. The recording apparatus according to claim 1, wherein
the first processing casing and the second processing casing are linked in a direction along a conveying direction of a recording medium, wherein
the first processing portion is a recording portion configured to record an image on a recording medium, and wherein
the second processing portion is a fixing portion configured to fix the image recorded by the recording portion onto the recording medium.

13. The recording apparatus according to claim 12, further comprising:
a third processing casing, which is linked to the second processing casing in a direction along the conveying direction of the recording medium, and which includes a third conveying path configured to convey the recording medium in the conveying direction and a cooling portion configured to cool the recording medium on which the image is fixed by the fixing portion; and
a third electric casing, which includes a third electric portion to control the cooling portion, and which is separably linked to the third processing casing in the width direction, independently from the second electric casing.
